(19) United States
(12) Patent Application Publication
(10) Pub. No.: US 2014/0041965 A1
(43) Pub. Date: Feb. 13, 2014

(54) LADDER SUPPORT SYSTEM

(71) Applicant: Industrial Safety Systems, LLC, Green Bay, WI (US)

(72) Inventors: Jason Hess, Suamico, WI (US); Jonathan T. Krouth, Port Washington, WI (US)

(73) Assignee: Industrial Safety Systems, LLC, Green Bay, WI (US)

(21) Appl. No.: 13/962,268

(22) Filed: Aug. 8, 2013

Related U.S. Application Data
(60) Provisional application No. 61/680,862, filed on Aug. 8, 2012.

(51) Int. Cl. E06C 7/18

(52) U.S. Cl. CPC E06C 7/188
USPC 182/107; 248/205.1; 248/558; 29/428

(57) ABSTRACT

A ladder support system includes a support arrangement affixed to a ladder at a first end. The support arrangement includes a proximal link coupled between the ladder and a distal link. The distal link includes a distal end configured to engage an upper surface of a structure such as a building or house in a secure manner to thereby secure the ladder thereto. The ladder support system may include an actuator arrangement configured to move the support system between a retracted and extended orientation. In another construction, the support system is configured to be selectively removable from the ladder as desired.

### CROSS-REFERENCE TO RELATED APPLICATIONS

This application claims priority to U.S. Provisional Patent Application No. 61/680,862 filed on Aug. 8, 2012 and entitled Ladder Support System, the entirety of which is hereby incorporated by explicit reference thereto.

### BACKGROUND OF THE INVENTION

This invention relates to ladders and more particularly extension ladders and in particular to a support system for securing an extension ladder to a structure such as, e.g., a house, other residence, commercial building, or the like so that a user may safely climb up and down the extension ladder.

Ladders, such as extension ladders are susceptible to shifting, dislocating and potentially falling when they are not properly placed adjacent a structure, such as a building or home. Typically, ladders are to be erected using a four-to-one ratio in which the distance from the base of the structure to the highest point making contact with the ladder is four times greater than the distance from the base of the structure to the feet of the ladder. Utilizing this ratio greatly reduces the potential for ladder failure, common when the feet of the ladder are either too near or too far from the structure to be climbed. Additional improvements, such as pivotable slip-resistant feet have been used to improve ladder stability.

However, such ladders suffer from a number of known disadvantages. In particular, such improvements focus exclusively on improving stability at the bottom of the ladder.

### SUMMARY OF THE INVENTION

In a first construction of the present invention the aforementioned drawbacks are solved by providing a ladder support system that engages the structure to be climbed at the upper end of the ladder. In one embodiment, the ladder includes a hand operated actuator located at the base of the ladder, which is operably connected to a support arrangement located at the opposing end of the ladder. Once the ladder is placed in its desired location, an operator activates the actuator while standing on the ground. In turn, proximal and distal links of the support arrangement are rotated into an extended orientation in which they engage the upper surface of the structure. With the support arrangement locked in its extended orientation, the operator may then climb the ladder while the support arrangement inhibits the ladder's undesirable lateral movement at the top of the ladder, and prevents potential ladder slipping or falling.

In another construction of the present invention, a ladder support system includes a pair of opposing mounting plates disposed toward the upper end of the ladder. The mounting plates are coupled to one another by a connecting element and may be selectively movable along the upper length of the ladder. The mounting plates include a number of apertures configured to be coupled with corresponding apertures of a first end of a proximal pivotable link by a fastener or similar element. The apertures may be arranged to allow for the proximal link to be secured at a desired angle relative to the ladder. The second end of the proximal link may include a number of longitudinally spaced apertures configured to be aligned with a corresponding aperture of a first end of a distal link configured to be mounted relative to the proximal link. In particular, the distal link may include an aperture sized and shaped to be fit over an end of the proximal link to allow the distal link to be movable relative thereto to enable an operator to position the distal link at a number of locations along the length of the proximal link. The distal link includes a second end opposite the first end that is configured to engage an upper surface of a structure to thereby brace the upper length of the ladder relative to the upper surface of the structure. When the distal link is engaged with the upper surface of the structure, the operator can then climb the ladder in a secure manner.

Various other features, objects and advantages of the present invention will be made apparent from the following detailed description and the drawings.

### BRIEF DESCRIPTION OF THE DRAWINGS

The drawings illustrate representative embodiments presently contemplated for carrying out the invention.

In the drawings:

FIG. 1 is an isometric view of a ladder employing a ladder support system according to a first construction of the present invention showing the ladder support system in a first, retracted orientation;

FIG. 2 is a partial isometric view of a support arrangement of the ladder support system taken along lines 2-2 of FIG. 1 and showing the support arrangement being moved from a retracted orientation to an extended orientation;

FIG. 3 is a partial isometric view of an actuator arrangement of the ladder support system taken along lines 3-3 of FIG. 1 and showing the actuator arrangement being moved from a first position to a second position;

FIG. 4 is an isometric view of the ladder support system of FIG. 1 showing the support arrangement moved to the extended orientation;

FIG. 5 is an isometric view of a ladder employing a ladder support system according to another construction of the present invention;

FIG. 6 is an isometric view of the ladder support system of FIG. 5;

FIG. 7 is a front elevation view of the ladder support system of FIG. 5;

FIG. 8 is a side elevation view of the ladder support system of FIG. 5;

FIG. 9 is a top plan view of the ladder support system of FIG. 5; and

FIG. 10 is an exploded isometric view of the ladder support system of FIG. 5.

### DETAILED DESCRIPTION

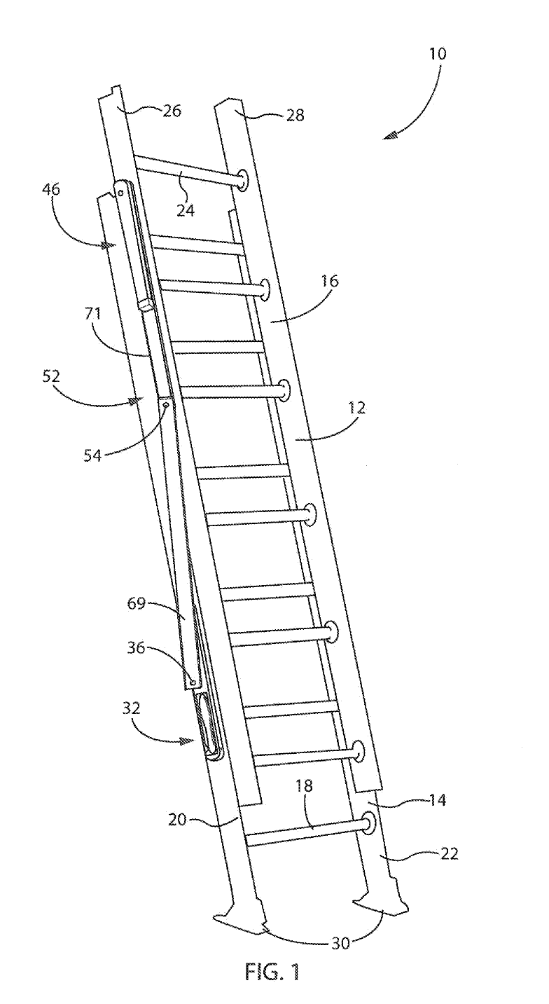

Referring now to the drawings, and initially, FIG. 1, a ladder support system 10 is provided on a ladder 12 shown here as an extension or telescopic ladder; it is understood, however that the support system 10 may be incorporated into any type of ladder including a fixed-length ladder. The ladder 12 includes a lower length 14 and an upper length 16 that is telescopically movable relative to the lower length 14 to extend and retract therefrom to thereby extend or retract, respectively, the effective length of the ladder 12. The lower length 14 includes a number of rungs 18 supported between a pair of upright support elements 20 and 22, while upper length 16 includes a number of rungs 24 supported between a pair of upright support elements 26 and 28. As shown in FIG. 1, the upright support element 20 of the lower length 14 is located adjacent to the upright support element 26 of the upper length 16, and the upright support element 22 of the lower length 14 is located adjacent the upright support element 28 of the upper length 16. The upright support elements 20 and 22 of the lower length 14 are further supported by feet 30. The lengths 14, 16 may be coupled to one another in a conventional manner in which the lower length 14 includes a number of internal guides (not shown) disposed on the corresponding interior portions of the support elements 20 and 22. The guides are configured to be releasably engaged by corresponding projections (not shown) carried on the external surfaces of the upright support elements 26, 28 of the upper length 16.

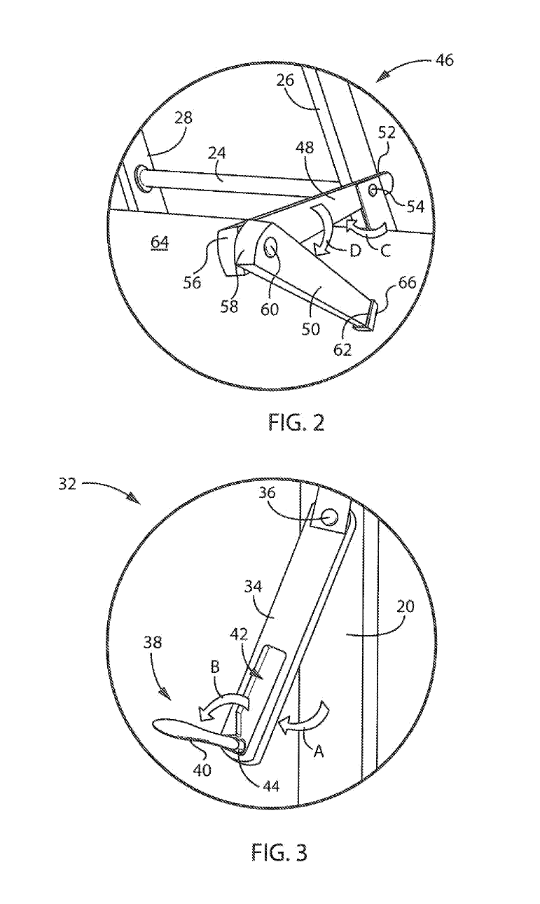

Turning to FIG. 2, the support system 10 includes an actuator arrangement 32 coupled to the upright support elements 20 of the lower length 14. The actuator arrangement 32 includes a bar element 34 pivotable about a pin 36 relative to the upright support element 20 of the lower length 14, for movement between a stored position in which the bar element 34 is generally aligned parallel with the longitudinal axis of the upright support element 20 and an activated position in which the bar element 34 is rotated about the pin 36 in a direction indicated by arrow A. The bar element 34 further includes a handle arrangement 38 including a handle element 40 extendible from a recess 42 in the bar element 34. The handle element 40 extends from recess 42 in the direction indicated by arrow B, such that it can be grasped by an operator of the ladder 12. In particular, the handle element 40 may be coupled to the bar element 34 by a pin 44 or similar element so that the handle element 40 may be rotated from a stored position in which the handle element 40 extends axially within the recess 42 and is generally aligned with the bar element 34 to an operative position in which the handle element is pivoted about the pin 44 perpendicular to the bar element 34.

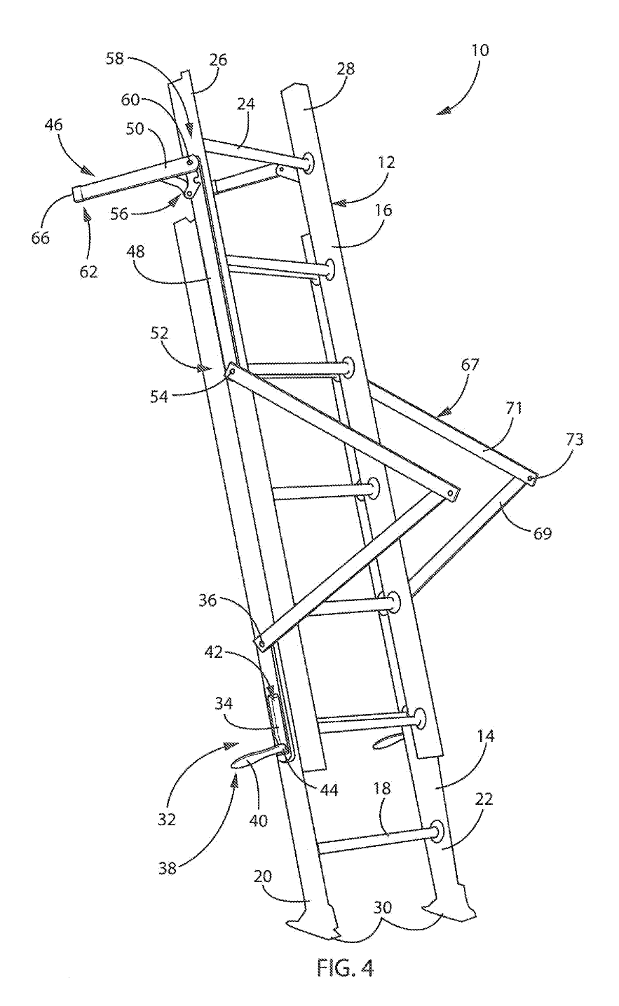

Referring now to FIGS. 3 and 4, the support system 10 further includes a support arrangement 46 coupled to an upright support element 26 of the upper length 16 on the same side of the ladder 12 as the actuator arrangement 32. However, it is considered within the scope of the invention that the actuator arrangement 32 may be operably connected to a support arrangement 46 located on an opposing side of the ladder 12, or to two support arrangements 46 located one on each side of the ladder 12. The support arrangement 46 is operatively coupled to the actuator arrangement 32 as will be described below. The support element 46 may include a proximal link 48 and a distal link 50 pivotally coupled to one another. The proximal link 48 includes a first end 52 rotatably coupled to the upright support element 26 of the upper length 16 by a pin 54 or similar element. The proximal link 48 is movable between a retracted position in which it is generally aligned parallel with the longitudinal axis of the upright support element 26 of the upper length 16 and an extended position in which the proximal link 48 is rotated about pin 54, in the direction indicated by arrow C, into an outwardly extending position relative to the upper length 16. In the outwardly extended position, the proximal link 48 may be generally perpendicular relative to the longitudinal axis of the upright support element 26, although it is understood that any other outwardly extending angle may be employed. The proximal link 48 includes a second end 56 opposite the first end 52, which is coupled to a first end 58 of the distal link 50 by a pin 60 or similar element. The distal link 50 is also movable between a retracted position in which it is generally aligned parallel with the longitudinal axis of the upright support element 26 of the upper length 16 and an extended position in which the distal link 50 is rotated about pin 60, in the direction indicated by arrow D, forming a acute angle with respect to the proximal link 48, at a location offset from the upright support element 26 of the upper length 16 by a distance approximately equal to the length of the proximal link 48. The distal link 50 includes a second end 62 opposite the first end 58, which is configured to engage a structure 64 such as the roof or other surface of a home, residential or commercial building, etc., when the proximal link 48 and distal link 50 are rotated into their respective extended positions. The second end 62 of the distal link 50 may include a stopper element 66 coupled thereto and configured to prevent the distal link 50 from damaging the structure 64 when the distal link is in its extended position. With the distal link 50 in the extended position, the distal link 50 and proximal link 48 form an acute angle, and function as a brace for securing the upper area of the ladder 12 to the structure 64.

In use, the ladder support system 10 is operated by an individual placing the ladder 12 in the desired location adjacent a structure 64 such as a home, residential or commercial building, etc. The ladder 12 is then expanded to the desirable length by the user extending the upper length 16 relative to the stationary lower length 14 in a conventional manner, with the interior guides of upright support elements 20 and 22 engaging the corresponding projections of upright support elements 26, 28. At the desired length, the support arrangement 46 will extend above the edge of an upper surface of the structure 64, such that the support arrangement 46 can engage the upper surface of the structure 64, when in an extended position.

With the ladder 12 is the desired location and extended position, the operator may now engage the actuator arrangement 32. The operator extends the handle element 40 from the recess 42 within the bar element 34, in the direction of arrow B. By grasping the handle element 40, the operator may rotate the bar element 34 around pin 36 in the direction of arrow A. By means of a linkage mechanism 67, the rotation of bar element 34 is translated to the support arrangement 46, to induce the support arrangement 46 to rotate from the retracted position to the extended position. The linkage mechanism 67 may be located within the interior space of the hollow upright support elements 20, 26, or may alternatively be located on the exterior surface of the ladder 12. In one embodiment the linkage mechanism 67 is a gear mechanism that translates the rotation of the actuator arrangement 32 to the support arrangement 46 via one or more rotating shafts and gears. Alternatively, the linkage mechanism 67 may be a cable, belt or chain driven mechanism or any alternate drive mechanism as is known in the art for transferring the rotational movement of the actuator arrangement 32 to the support arrangement 46. In one embodiment, the length of the linkage mechanism 67 is expandable as to compensate for the variable lengths of the extension ladder 12. As illustrated, the linkage mechanism 67 is in the form of a two-bar linkage including an actuator arrangement link 69 operably and pivotally coupled to the actuator arrangement 32 by pin 36 or similar connector and a support arrangement link 71, which is pivotally coupled to the actuator arrangement link 69 by a pin 73 or similar connector and the support arrangement 46 by pin 54 or similar connector. It is understood that the linkage mechanism 67 is but one way of coupling the support arrangement 46 to the actuator arrangement 32, and a variety of other known connection types may be utilized in practicing the present construction of the support system 10.

As a result of rotating the actuator arrangement 32, the operator induces the rotation of the proximal and distal links 48, 50 of the support arrangement 46 from their respective retracted positions into an extended position, namely with the proximal link 48 rotating about pin 54 in a direction indicated by arrow C and the distal link 50 rotating about pin 60 in a direct indicated by arrow D. The operator then stops rotating the handle element 40 once the stopper element 66 of the second end 62 of the distal link 50 forms an acute angle relative to the proximal link 48 to form a brace for securing the ladder 12 to the structure 64. In this position, the proximal and distal links 48, 50 engage the upper surface of the structure 64, to secure the ladder 12 to the structure. With the links 48, 50 of the support arrangement 46 in the desired locations, the operator then folds the handle element 40 into the recess 42 within the bar element 34. By replacing the bar element into the recess, the operator prevents rotation of the actuator arrangement 32 while the ladder 12 is in use. In one embodiment, the support system 10 may further include a directionally selectable ratchet (not shown) integrated into the actuator arrangement 32, to prevent any unintended disengagement of the support arrangement 46, while the ladder 12 is in use. Alternatively, the support arrangement 46 may be spring loaded or alternatively secured in place once extended during use. Once the support arrangement has been engaged, the operator may ascend the ladder, without the ladder moving either laterally along the face of the structure 64 or disengaging from the face of the structure 64. As can readily be appreciated, the steps set forth above are reversed after use in order to return support system 10 to its storage or inoperative position.

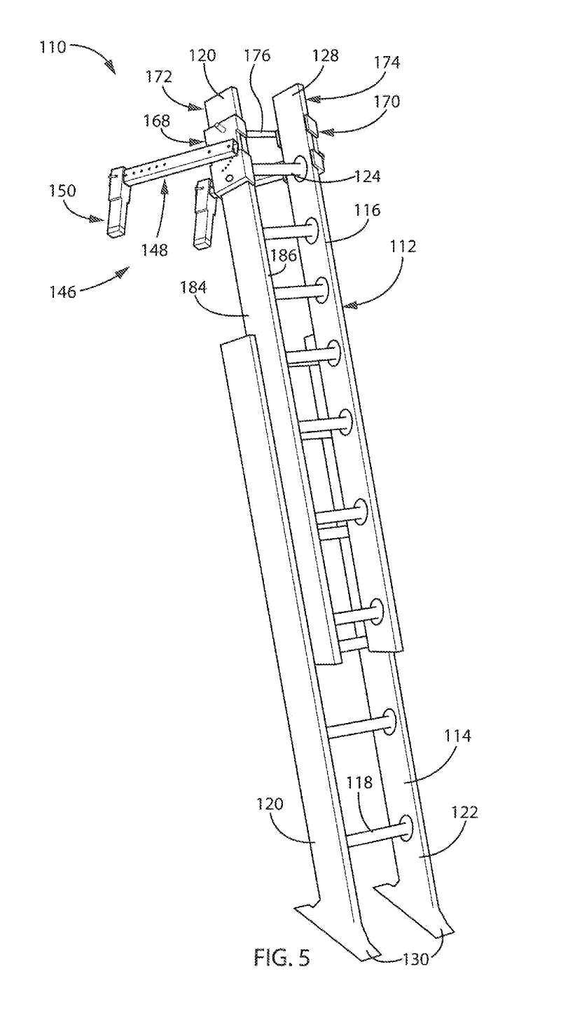

With reference now to FIGS. 5-10, a second construction of the present invention, in the form of ladder support system 110, is illustrated. Unless otherwise indicated, the structures operate as previously described herein, and each of the structures is similarly numbered and incremented by 100. The elements of the support system 110 of the present construction may be constructed from a metallic material such as aluminum, plastic, or any other suitable material.

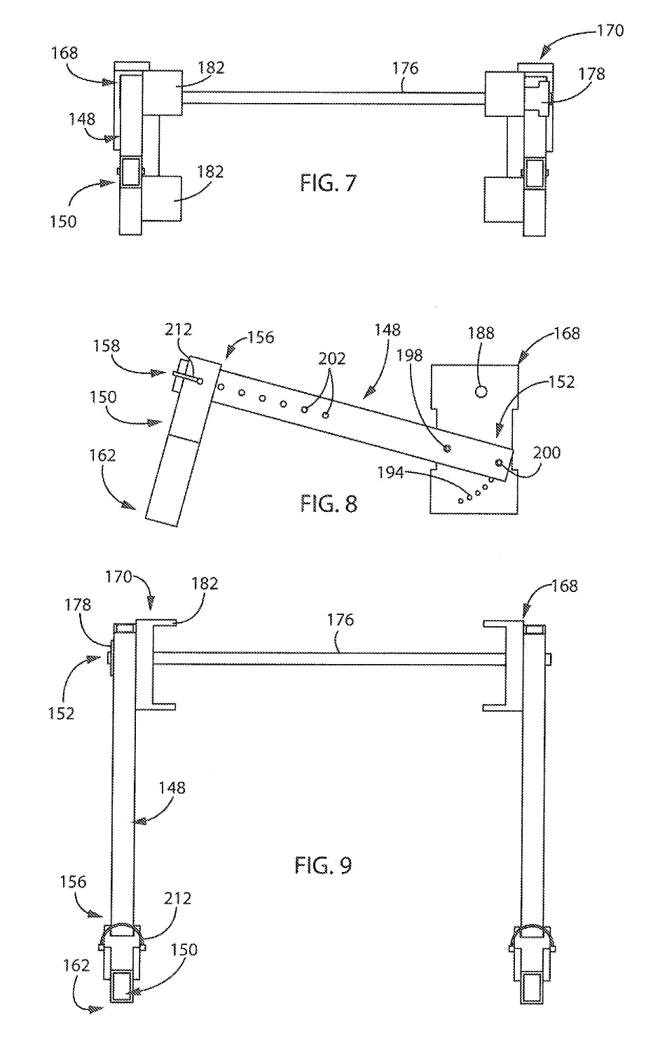

The support system 110 of the present construction includes a pair of opposing mounting elements 168 and 170, which are coupled to a left side 172 and right side 174, respectively of the upper length 116 of the ladder 112. The mounting elements 168 and 170 are coupled to one another across a width of the ladder 112 by a connecting element 176, which may be in the form of a threaded rod or the like. A knob 178 (see FIG. 7) or similar element may be provided and coupled to an end of the connecting element 176 and configured to be threadedly secured to the connecting element 176 to thereby secure the support system 110 to the ladder 112. The knob 178 may be tapped and configured to engage the threads of the connecting element 176. As illustrated, the knob 178 is coupled to one end of the connecting element 176, but it is understood that the knob 178 may be utilized on either side of the support arrangement 146. The knob 178 may be configured to be threaded onto an end of the connecting element 176 to thereby secure the connecting element to the corresponding mounting element 168 or 170. The knob 178 may be configured to be selectively manually loosened or tightened by hand so that the operator may selectively remove the support system 110 from the ladder 112.

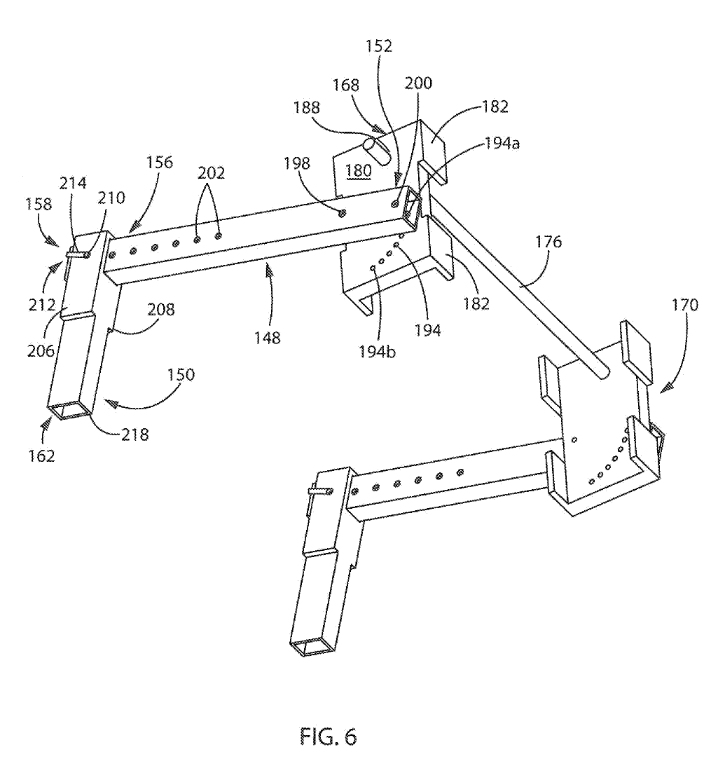

With particular reference now to FIG. 6, the mounting element 168 is shown in additional detail. The mounting elements 168 and 170 each support a proximal link 148 having a first end 152 coupled to the respective mounting element 168 and 170 and a second end 156 coupled to a respective first end 158 of a distal link 150. It is to be understood that the mounting elements 168 and 170 are similarly constructed and are mirror images of one another such that the description of mounting element 168 applies equally to mounting element 170, unless otherwise indicated. The mounting element 168 is configured to be positioned anywhere along a length of the upper length 116 of the ladder such that the support system 110 according to the present construction may be selectively positioned to ensure proper engagement between the support system 110 and the structure 64 as may be readily appreciated. The mounting element 168 includes a generally planar face 180 from which a number of tab elements 182 extend from toward the ladder 112. The tab elements 182 are configured to be received over opposing edges 184 and 186 (see FIG. 5) of the upper length 116 such that the face 180 may be positioned closely up against the side of the ladder 112. The tab elements 182 may be configured to be snap fit or otherwise arranged to be securely coupled over the edges 184 and 186 of the ladder 112.

The mounting element 168 further includes a generally centrally located upper aperture 188, which is configured to securely receive an end of the connecting element 176 therethrough. As may be readily appreciated, the opposing mounting element 168 includes a corresponding upper aperture 188 that receives the opposing end of the connecting element 176 therethrough. The upper aperture 188 may be threaded so as to threadedly receive the end of the connecting element 176 as previously described. In this manner, the mounting elements 168 and 170 are coupled to one another to ensure alignment thereof. That is, by connecting the mounting elements 168 and 170 across the width of the ladder 112 by the connecting element 176 the operator ensures that the support system 110 is arranged so that the elements thereof are aligned with one another to ensure safe engagement between the support system 110 and the structure 64.

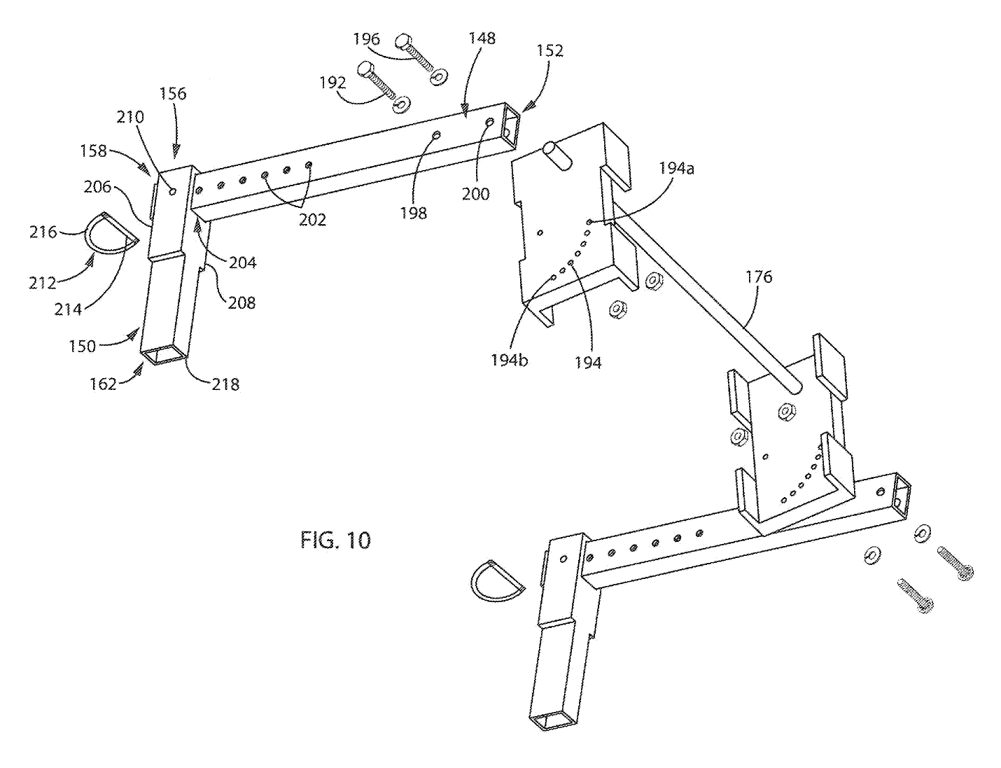

With continuing reference to FIG. 6 and now additional reference to FIGS. 7 and 10, the mounting element 168 further includes a mounting aperture 190 configured to receive a fastener 192 to thereby couple the mounting element to the proximal link 148 at a first location nearest the edge 184 of the ladder 112. The mounting element 168 further includes a number of angular mounting apertures 194 positioned nearer the edge 186 of the ladder 112. As illustrated, the angular mounting apertures 194 are provided in a generally arcuate pattern wherein the angular mounting apertures 194 are spaced from one another along the face 180 beginning nearer the edge 186 and extending downwardly and toward the edge 184. In this manner, the angular mounting apertures 194 define a number of angular positions with which the proximal link 148 may be secured thereto. It is to be understood, however, that any number of alternative arrangements of the angular mounting apertures 194 may be utilized.

In one construction of the present invention, the angular mounting apertures 194 are arranged such that the upper-most angular mounting aperture 194a is positioned at approximately 15.5 degrees relative to a longitudinal axis defined by the ladder 112. The remaining angular mounting apertures 194 may then be incremented by approximately 10 degrees relative to the previous angular mounting aperture 194 going from the upper-most angular mounting aperture toward the lower-most mounting aperture 194b. In this manner, the angular mounting apertures are configured to accommodate a variety of different roof pitches.

The first end 152 of the proximal link 148 is engaged with one of the angular mounting apertures 194 by a fastener 196, which may be in the form of a bolt, screw, or similar element. The fastener 196 may be selectively removable from the angular mounting apertures 194 and proximal link 148 to enable the user of the support system 110 to adjust the angle with which the proximal link 148 is positioned relative to the ladder 112.

With continuing reference now to FIGS. 6-10, the proximal links 148 may have a generally rectangular cross section and may be generally hollow. The proximal links 148 include first and second mounting apertures 198 and 200 positioned near the first end 152 for coupling the proximal links 148 to the mounting aperture 190 and angular mounting apertures 194, respectively, as previously described. Nearer the second end 156 of the proximal links 148, a number of distal link mounting apertures 202 are provided and are spaced along a length of the proximal links 148 and configured to allow for mounting of the distal links 150 to the proximal links as will be described.

The distal links 150 may include a generally rectangular cross section and may be configured to be coupled to the respective proximal link 148 at a right angle thereto. Understandably, the distal link 150 and proximal link 148 may be coupled to one another at a variety of orientations and angles. In particular, the first end 158 of the distal links 150 may include a rectangularly shaped aperture 204 configured to be received over the second end 156 of the proximal link in a slidable manner. Understandably, the aperture 204 may have any suitable size and shape so long as it is capable of allowing the distal link 150 to be received in a secure manner over the proximal link 148. The aperture 204 of each distal link 150 is defined by opposing distal link faces 206 and 208, each of which includes an aperture 210 through which a fastener 212 is to be received. As illustrated, the fastener 212 is shown as a safety pin having opposing engagement portions 214 that are configured to be received through the apertures 210 of the distal link and mounting aperture 204, wherein the opposing ends of the engagement portions 214 are connected to one another by an arcuate portion 216 configured to be grasped by the operator of the support system 110 for removing the fastener 212 from the proximal link 148 and distal link 150. Understandably, the fastener 212 may be a bolt, screw, pin, or similar fastener configured to be received through the aligned apertures 210 and the distal link mounting apertures 202 to thereby secure the distal link 150 to the proximal link 148 at a right angle. The fastener 212 may be selectively removable to enable the operator to move the distal link 150 relative to the proximal link 148 in a longitudinal manner to thereby position the distal link 150 at a preferred location to enable the distal link 150 to engage an upper surface of the structure 64.

Opposite the first end 158 of the distal link 150, the second end 162 includes an upper surface engaging portion 218. The upper surface engaging portion 218 may have a smaller cross section relative to the first end 158. The upper surface engaging portion 218, as illustrated, has a rectangular cross section and is generally hollow, although it is understood that alternative constructions are within the scope of the invention. The surface engaging portion 218 is configured to engage an upper surface of the structure 64 in a secure manner as previously described herein with respect to the first construction of the invention. The surface engaging portion 218 may further include a stopper element (not shown) like that of the previous embodiment to provide additional friction between the surface engaging portion 218 and the upper surface of the structure 64.

In operation, at least a portion of the support system 110 may be selectively removable from the ladder 112. In at least one construction of the support system 110, the mounting plates 168 and 170, connecting element 176 and knob 178 may be configured to stay coupled to the ladder 112 while the remainder of the support system 110 may be selectively removed so that the operator may store the ladder 112 when not in use. As necessary, the operator may adjust a relative position of the mounting plates 168 and 170 to a desired location along the length of the upper length 116 of the ladder 112. The operator may then secure each of the proximal links 148 to its corresponding mounting element 168 and 170 by inserting fasteners 192 through the first mounting aperture 198 of the proximal links and through the corresponding mounting aperture 190 of the mounting element 168. The fastener 192 may be secured by a nut or similar element configured to the back of the mounting element 168 or 170. The operator may then adjust the angle of the proximal link 148 relative to the mounting element 168 or 170 by aligning the second mounting aperture 200 of the proximal link 148 with the desired angular mounting aperture 194 and inserting a fastener 192 therethrough.

Next, the operator may couple each distal link 150 to its respective proximal link 148 by sliding the distal link 150 over a length of the proximal link 148 by aligning the aperture 204 perpendicularly to the length of the proximal link 148. Once the distal link 150 is located in the desired position, the fastener 212 may be threaded through the apertures 210 of the distal link and apertures 202 of the proximal link to thereby secure the distal link 150 to the proximal link 148.

As the proximal links 148 and distal links 150 are now positioned as desired, the ladder 112 may be positioned for engagement with the structure 64. The operator may position the lower length 114 of the ladder 112 at a desired position such that the upper length 116 comes to rest against a portion of the structure 64. The distal links 150 are then brought into engagement with the upper surface of the structure 64 such that surface engaging portion 218 of the distal links 150 secure the ladder 112 to the structure 64. In this manner, the operator of the support system 110 may use the ladder 112 to climb up and down the ladder 112 in a more secure manner.

Finally, once the operator is finished with the ladder 112, the operator may selectively remove the proximal link 148 and distal link 150 from the ladder 112 so that the ladder 112 may be stored. In particular, the operator may simply loosen the fasteners 192 and 196 such that the proximal link 148 and distal link 150 may be removed from ladder 112 as a unit for subsequent use thereof.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

I claim:

1. A support system for a ladder, the support system comprising:
a support arrangement affixed to a ladder at an upper end of the ladder configured to engage a structure, the support arrangement including:
at least one proximal link having a first end coupled to the ladder and a second end opposite the first end,
at least one distal link having a proximal end coupled to the proximal link and a distal end configured to engage an upper surface of the structure, wherein the distal link is configured to operably engage the support to secure the ladder to the structure.

2. The support system of claim 1, further comprising an actuator assembly configured to selectively move the support arrangement between a retracted orientation and an extended orientation.

3. The support system of claim 2, wherein the actuator assembly comprises an actuator linkage operably coupled between the support arrangement and actuator assembly and configured to selectively move the support arrangement between the retracted orientation and extended orientation.

4. The support system of claim 3, wherein the actuator assembly comprises a handle configured to drive movement of the actuator linkage to move the support arrangement between the retracted orientation and extended orientation.

5. The support system of claim 1, wherein the distal link is movable relative to the proximal link along a longitudinal axis defined by the proximal link.

6. The support system of claim 1, wherein the proximal link is movable relative to the ladder to adjust an angle of the proximal link relative to a longitudinal axis of the ladder.

7. The support system of claim 1, wherein the at least one proximal link comprises a left proximal link and a right proximal link coupled to a left side and right side of the ladder respectively and wherein the at least one distal link comprises a left distal link and a right distal link coupled to the left proximal link and the right proximal link respectively.

8. The support system of claim 7, wherein the left proximal link and the right proximal link are coupled to one another by a support element that extends across a width of the ladder.

9. The support system of claim 1, wherein the support arrangement comprises at least one mounting element coupled between the proximal link and the ladder.

10. The support system of claim 1, wherein the distal link is coupled to the proximal link by a fastener.

11. The support system of claim 1, wherein the proximal link is angularly adjustable to adjust a position of the support arrangement relative to the upper surface of the structure.

12. A method of securing a ladder to a structure, the method comprising the steps of:
positioning a support arrangement comprising at least one distal link configured to engage the structure and at least one proximal link coupled between the distal link and the ladder for engagement with the structure;
engaging an upper surface of the structure with the support arrangement to thereby secure the ladder to the structure.

13. The method of claim 12, further comprising the step of moving the distal link of the support arrangement relative to the proximal link.

14. The method of claim 13, further comprising the step of adjusting an angular position of the proximal link relative to the ladder to adjust an angle of the distal link relative to the structure.

15. The method of claim 12, further comprising the step of actuating an actuator arrangement coupled between the ladder and the support arrangement to move the support arrangement between a retracted orientation and an extended orientation.

16. The method of claim 15, further comprising the steps of disengaging the support arrangement from the upper surface of the structure and actuating the actuator arrangement to move the support arrangement from the extended orientation to the retracted orientation.

17. The method of claim 15, wherein the actuating step further comprises rotating an actuator element.

18. A ladder comprising:
a lower length;
an upper length movably coupled to the lower length between a lowered orientation and a raised orientation;
a support arrangement movably coupled to the upper length and configured to engage an upper surface of a structure to thereby secure the ladder to the structure, wherein the support arrangement comprises,
a pair of proximal links having first ends coupled to opposing sides of the ladder and opposing second ends; and
a pair of distal links having first ends movably coupled to the respective second ends of the proximal links, wherein the distal links are configured to securely engage the structure.

19. The ladder of claim 18, further comprising a pair of mounting elements coupled between opposing sides of the ladder and the pair of proximal links and connected to one another by a connecting element across a width of the ladder.

20. The ladder of claim 18, further comprising an actuator arrangement coupled to the lower length of the ladder and configured to move the support arrangement between a retracted orientation and extended orientation.
